(19) United States
(12) Patent Application Publication
(10) Pub. No.: US 2026/0359739 A1
(43) Pub. Date: Nov. 12, 2026

(54) Methods And Devices For Restricting Or Eliminating Ticket Scalping

(71) Applicant: Grit & Stone, Rockville, MD (US)

(72) Inventors: David Walls-Kaufman, Crofton, MD (US); Gregory Powell, Rockville, MD (US)

(73) Assignee: Grit & Stone, Rockville, MD (US)

(21) Appl. No.: 19/672,728

(22) Filed: May 11, 2026

Related U.S. Application Data
(60) Provisional application No. 63/803,540, filed on May 10, 2025.
(60) Provisional application No. 63/904,504, filed on Oct. 23, 2025.

(51) Int. Cl. G06Q 10/02

(52) U.S. Cl. CPC G06Q 10/0281

(57) ABSTRACT

Ticket scalping is substantially reduced or eliminated using a ticketing system that, among other features, transparently publishes time-indexed pricing for tickets in advance of the sale of tickets.

### RELATED APPLICATIONS

This application claims priority to U.S. Provisional Application 63/803,540 filed May 10, 2025 (the “'540 Application”) and U.S. Provisional Application 63/904,504 filed Oct. 23, 2025 (the '504 Application”) and incorporates by reference the entire disclosures of the '540 and '504 Applications as if they were set forth in full herein.

### INTRODUCTION

This section introduces aspects that may be helpful to facilitate a better understanding of the described disclosure. Accordingly, the statements in this section are to be read in this light and are not to be understood as admissions about what is, or what is not, in the prior art.

Traditional ticketing systems are vulnerable to scalping, which prevents millions of dollars in revenue from being received by legitimate artists, teams, and venues. People (i.e., fans) often pay inflated prices on secondary markets to scalpers, while performers, teams and venue owners lose out on rightful revenue.

There have been attempts to eliminate scalpers, such as reverse Dutch auctions, but such techniques have not reduced scalping due to their reliance on bidding schemes. Other existing techniques fail to sufficiently control the resale of tickets which then “opens the door” for scalpers to control prices. Still other existing techniques are not transparent from a pricing standpoint, thereby undermining their acceptance and usage by the ticket-buying public.

Accordingly, it is desirable to provide methods and devices for restricting or eliminating ticket scalping that address the above shortcomings.

### SUMMARY

The inventors disclose various methods and devices for restricting or even eliminating ticket scalping, As discussed in more detail herein, the disclosed methods and devices are believed to substantially restrict ticket scalping by implementing one or more of the following steps: (1) transparently disclosing the process for pricing tickets in advance of their sale via time-indexed pricing values (e.g., a “price “ladder”) for example, (2) disallowing reactive bidding and clearing events, (3) controlling the transfer of the admission right to an event using a closed-system/market architecture, and (4) substantially reducing or even eliminating the circulation of a primary bearer instrument (e.g., a paper ticket).

For example, one exemplary computer-implemented method for restricting or eliminating ticket scalping using a closed ticket purchase system may comprise at least one electronic processor and at least one electronic memory, the method comprising: electronically generating, by the closed ticket purchase system, time-indexed pricing values comprising a plurality of future ticket prices respectively associated with corresponding future time periods for the event; electronically outputting, by the closed ticket purchase system, prior to occurrence of at least one of the corresponding future time periods, at least a portion of the time-indexed pricing values and the corresponding future time periods to a plurality of client devices or a third party ticketing system over a telecommunications network such that future ticket pricing is transparently published in advance of ticket purchase transactions; electronically generating, by the closed ticket purchase system, responsive to completion of an original ticket purchase transaction, a revocable identity-bound admission credential with unique identifying information and associating the generated credential and identifying information to a purchaser; and electronically restricting resale ticket transactions for the event such that all ticket resales are required to be processed through the closed ticket purchase system that processed the original ticket purchase transaction, wherein the time-indexed pricing values may comprise a time-indexed pricing ladder.

Such a method may further comprise one or more additional steps, such as: electronically outputting the entire time-indexed pricing values to the network; electronically verifying, by the closed ticket purchase system, during a requested resale transaction that the unique electronic code and the unique identifying information remain associated with an authorized ticket transaction prior to permitting transfer of the revocable identity-bound admission credential; electronically computing, by the closed ticket purchase system, an initial value representing an initial ticket price for an event based on historical ticket data stored in at least one electronic database; electronically monitoring, by the closed ticket purchase system, at least: (i) ticket sales velocity, (ii) remaining ticket inventory, and (iii) time remaining before commencement of the event; electronically generating a unique electronic code associated with the ticket purchase transaction and storing the unique electronic code in an electronic memory; eliminating circulation of a primary bearer instrument by restricting admission to the event by requiring presentation of the revocable identity-bound admission credential; and verifying the unique electronic code.

Further, electronically generating the time-indexed pricing values may comprise using (a) a non-linear time factor derived from a ratio of remaining time before the event relative to a total advertised time period for the event, and (b) a non-linear inventory factor derived from a ratio of remaining unsold tickets relative to a total quantity of tickets available for the event to generate the time-indexed pricing values.

The disclosure further provides a second method. In embodiments this method is a computer-implemented method for controlling electronic admission credentials for an event, where the method may comprise: electronically receiving, by a closed ticket purchase system comprising at least one electronic processor and at least one electronic memory, a request to purchase at least one ticket for an event from a client device or third party ticketing system over a telecommunications network; electronically receiving, by the closed ticket purchase system, purchaser-specific identifying information associated with a purchaser; electronically generating, by the closed ticket purchase system, responsive to approval of the purchase request, a revocable identity-bound admission credential corresponding to the purchaser and the event; electronically generating, by the closed ticket purchase system, a unique electronic code associated with the revocable identity-bound admission credential and storing the unique electronic code in memory; and electronically transmitting the unique electronic code to the client device associated with the purchaser.

Such a method may additional comprise one or more of the following steps: eliminating circulation of a paper ticket bearer instrument by restricting event admission to electronic verification of the revocable identity-bound admission credential; electronically receiving, from admission-control equipment at a venue, verification information associated with the unique electronic code at the closed ticket purchase system; and electronically communicating between the admission-control equipment and the closed ticket purchase system to verify that the unique electronic code corresponds to an authorized ticket transaction associated with the purchaser-specific identifying information; restricting transfer and resale of the revocable identity-bound admission credential such that all transfer requests and resale transactions are required to be processed through the closed ticket purchase system; electronically denying admission or transfer authorization when the unique electronic code fails verification against stored transaction data maintained by the closed ticket purchase system.

One example of unique electronic code may comprise a quick-response (QR) code associated with a ticket purchase transaction.

On such a method the admission-control equipment may electronically communicate with the closed ticket purchase system through a third party ticketing system to verify the revocable identity-bound admission credential.

The disclosure sets forth many methods, two of which were just outlined, A third method comprises a computer-implemented method for transparently controlling ticket pricing for an event, where the method comprises: electronically retrieving, by a closed ticket purchase system, historical ticket transaction data associated with one or more prior events that are similar to the event; electronically generating, by the closed ticket purchase system, using the historical ticket transaction data an initial ticket price for the event; electronically generating, by the closed ticket purchase system, time-indexed pricing values comprising a plurality of future ticket prices respectively associated with future time periods before commencement of the event; electronically computing successive ticket prices comprising the time-indexed pricing values using one or more of: (i) a demand factor based on ticket sales velocity, (ii) a time factor based on remaining time before the event, and (iii) an inventory factor based on remaining unsold ticket inventory, wherein at least one of the time factor or the inventory factor is non-linearly computed by the closed ticket purchase system.

Such a method may further comprise; electronically publishing, by the closed ticket purchase system through a telecommunications network and prior to occurrence of corresponding future time periods, future ticket prices of the time-indexed pricing to a plurality of client devices; disallowing reactive bidding and ticket-price auctions; electronically updating, by the closed ticket purchase system, ticket prices at successive time thresholds based on monitored event demand and monitored ticket inventory; electronically controlling resale transactions through the closed ticket purchase system to prevent external resale transactions outside the system, or electronically publishing future pricing information sufficiently in advance to reduce information asymmetry between ticket purchasers and ticket resellers, or electronically repeatedly reducing ticket pricing in controlled stages corresponding to distinct purchaser demand groups having different price sensitivities.

In addition to the above methods the disclosure also describes and supports apparatuses, systems, devices and mediums (e.g., electronic memories) for completing each of the methods described above and elsewhere herein.

It is believed that the methods, apparatuses, systems, devices and mediums described herein reduce, restrict or eliminate the ability for a ticket scalper to exploit tickets for resale which, in turn, provides artists, sport leagues and venues unprecedented insight into fan enthusiasm and direct revenue streams.

### BRIEF DESCRIPTION OF THE DRAWINGS

FIG. 1 depicts a simplified block diagram of an exemplary system that may be used to implement one or more of the inventive methods according to examples of the present disclosure.

FIG. 2 depicts an exemplary flow diagram according to one or more embodiments of the present disclosure.

FIG. 3 depicts a graphical representation illustrating an exemplary demand for tickets for an event versus pricing according to embodiments of the disclosure.

FIG. 4 depicts an exemplary time-indexed, price ladder according to an embodiment of the disclosure.

FIGS. 5A to 5D illustrates the display of exemplary data sets and dashboards generated by an administrative device, for example, according to embodiments of the disclosure.

### DETAILED DESCRIPTION, WITH EXAMPLES

Exemplary embodiments of methods, systems and devices for restricting or eliminating ticket scalping are described herein and are shown by way of example in the drawings. Throughout the following description and drawings, like reference numbers/characters refer to like elements.

It should be understood that although specific embodiments are discussed herein, the scope of the disclosure is not limited to such embodiments. On the contrary, it should be understood that the embodiments discussed herein are for illustrative purposes, and that modified and alternative embodiments regarding the specific methodologies, systems and devices used to restrict or eliminate ticket scalping that otherwise fall within the scope of the disclosure are contemplated.

It should also be noted that one or more exemplary embodiments may be described as a process or method (the words “method” or “methodology” may be used interchangeably with the word “process” herein). Although a process/method may be described as sequential, it should be understood that such a process/method may be performed in parallel, concurrently or simultaneously. In addition, the order of each step within a process/method may be re-arranged. A process/method may be terminated when completed, and may also include additional steps not included in a description of the process/method if, for example, such steps are known by those skilled in the art.

As used herein, the term “and/or” includes any and all combinations of one or more of the associated listed items. As used herein, the singular forms “a,” “an” and “the” are intended to include the plural form, unless the context and/or common sense indicates otherwise.

It should be understood that when a system, device, or a component or element is referred to, or shown in a figure, as being “connected” to (or other tenses of connected) another system, device, component or element such systems, devices, components or elements may be directly connected, or may use intervening components or elements to aid a connection. In the latter case, if the intervening systems, devices, components or elements are well known to those in the art they may not be described herein or shown in the accompanying figures for the sake of clarity.

It should be noted that the elements (e.g., systems, devices, servers, processors, databases) illustrated in the figures are not drawn to scale, are not representative of an actual shape or size and are not representative of any actual layout, manufacture's drawing or visual. Rather, the elements are drawn to simply help explain the features, functions and methods of exemplary embodiments of the present disclosure described herein and covered by the claims set forth at the end of this description.

As used herein the term “client device” and “administrative device” refers to an apparatus that may comprise, among other things, electronic elements (e.g., a modem) that functions as a radio frequency transceiver to wirelessly or via wired means (i) transmit signals, messages and data to one or more elements (e.g., devices, apparatuses) of a telecommunications network and (ii) receive signals, messages and data from the one or more elements of the network and at least one electronic processor and associated electronic memory.

As used herein the phrase “electronic processor” or “processor” means one of: electronic circuitry, at least one electronic processing core, one or more microprocessors with accompanying digital signal processor(s), one or more electronic processor(s) without an accompanying digital signal processor, one or more coprocessors, one or more multi-core processors, one or more graphics processing units (GPU), one or more electronic controllers, electronic processing circuitry, one or more computers, one or more computing servers, various other electronic processing elements including integrated circuits (for example, an application specific integrated circuit (ASIC), a field programmable gate array (FPGA), and/or the like), or some combination thereof.

Notably, when illustrated in the figures as a single processor, in some embodiments the processor may comprise a plurality of electronic processors or processing cores. In any event, when combined with at least one electronic memory that stores electronic instructions the instructions may be retrieved and executed by at least one of the electronic processors to cause the processor to complete the functions and features described herein, including, but not limited to, the generation of control signals that may be sent to one or more of the components and elements of a system described herein to complete the functions and features disclosed herein and/or the reception/transmission of electronic data from/to the one or more of the components or elements of a system described herein to complete the functions and features disclosed herein.

As used herein, the phrase “electronic memory” (referred to as “memory” herein) means a non-transitory, electronic storage medium (e.g., volatile or non-volatile memory device). Examples of non-transitory, electronic storage media include, but are not limited to: a random access memory (RAM); a programmable read only memory (PROM); an erasable programmable read only memory (EPROM); a FLASH-EPROM; a magnetic computer readable medium (e.g., a floppy disk, hard disk, magnetic tape, any other magnetic medium); an optical computer readable medium (e.g., a compact disc read only memory (CD-ROM); a digital versatile disc (DVD); a Blu-Ray disc (BD), the like, or combinations thereof), or any other non-transitory medium from which an electronic processor can retrieve stored electronic instructions that when executed cause an apparatus or device to perform one or more functions, features or steps in a method or process.

It should be understood that a system, client or administrative device described herein may complete features, functions and steps of a disclosed embodiment using a web browser that is a part of an interface or one or more applications (often referred to herein as an “APP” or “APPs”) that have been installed into, or downloaded onto such a device. An “APP” may include “content” (e.g., text, audio and video files), signaling and configuration files. For the sake of convenience and not limitation, the terms “APP” or “application” are used herein to refer to any application, but use of such a term also includes a reference to any file or data.

For example, an APP to be downloaded onto a device may also reside or be stored on one or more hardware devices, such as a server in whole and/or in part, the later indicating that the APP may be distributed among, and by, several devices or servers. An APP may be downloaded to a device from a server (or servers) or have been otherwise provided and installed on such a server. A given device may have a need for one or more of the APPs installed on a server. Accordingly, the embodiments described herein includes protocols, necessary hardware, software and firmware resident on a device for transmitting and receiving (i.e., “transceiving”) an APP, content and/or content identification information relating to the APP from/to a server and vice-versa. Depending on the content to be transmitted, an APP may be installed directly on a device or may be downloaded from a server by initiating a request to a server to receive a local copy of the APP. When a discussion herein describes the sending and reception of data (i.e., transmissions and receptions) from/to a device to/from a device a web browser and/or APP may be used to complete such transmissions and receptions.

It should be further understood that the systems and devices (e.g., servers) described herein may include the ability for a third party or a user to access all, or some, of the functionality of the systems, devices or servers described herein using, for example, an application programming interface (API). In general, an API is a set of subroutine definitions, protocols, and tools that the systems, devices and servers described herein provide to enable users and third parties to build connections to the systems, devices and servers described herein as well create their own software and applications. More particularly, the systems, devices and servers described herein may provide APIs that are suitable for a web-based ticketing system, operating system, database system, computer hardware, or software library. The API may include a specification, including, but not limited to, routines, data structures, object classes, variables, or remote calls. POSIX, Microsoft Windows API, the C++Standard Template Library, and Java, to name just a few examples.

As used herein, the word “compute”, “computed”, “computations” and its tenses means an electronic computation by an electronic processor of a respective apparatus (e.g., system, administrative device, client device, server) that executes electronic instructions from its at least one electronic memory that has caused the respective apparatus to complete a function, feature or step in a process/method.

As used herein, the term “embodiment” or “exemplary” mean an inventive example that falls within the scope of the present disclosure.

A used herein the phrase “closed ticket purchase system” describes an electronic system that processes and verifies the original purchase of all tickets for an event and verifies all subsequent resale purchases of all tickets for the event. Said another way, as set forth herein a closed ticket purchase system electronically restricts resale ticket transactions for an event such that all ticket resales are required to be processed through such a system that processed the original ticket purchase transaction.

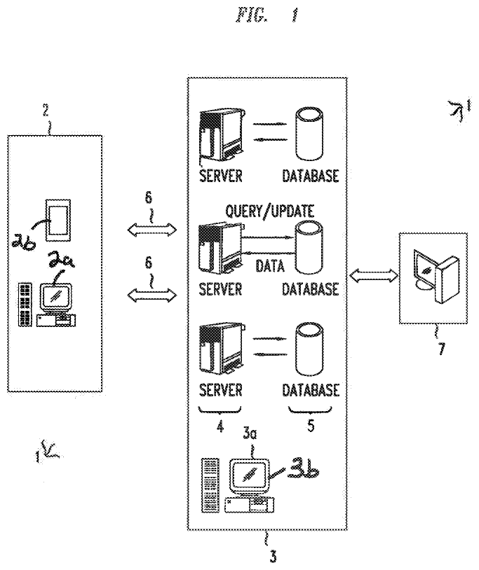

Referring to FIG. 1 there is depicted a simplified block diagram of a network 1 for implementing one or more of the exemplary methods disclosed herein or their equivalents.

As shown, the network 1 may comprise a telecommunications network that may comprise one or more electronic processors 4 (e.g., servers) and one or more end-user or client devices 2 (e.g., smartphones, PCs, laptops, iPads®, etc., hereafter “client devices” or simply “clients”) connected to the servers 4 via one or more wireless or wired channels 6. The one or more servers 4 may form a private network or may be part of, or communicatively connected to a “cloud” network (e. g., AWS or Google cloud network). In an embodiment, the network 1 may also include one or more administrative user devices 3a (only one is shown for brevity). In an embodiment, an administrative user device 3a may communicate with the servers 4, and/or may communicate with each of the client devices 2 via wireless or wired means (only telecommunication channels 6 are shown for brevity, though other known channels may connect the administrative user device 3a to the client devices 2).

Connected to the inventive network 1 is a third party ticketing system 7.

As used herein the combination of the administrative devices 3a, servers 4 and associated databases 5 may comprise an exemplary anti-scalping system 3. It should be understood, however, that the present disclosure may include additional components in an exemplary anti-scalping system 3 or fewer components. For example, another embodiment of an anti-scalping system 3 may only include an administrative user device 3a or alternatively, may additionally include a third party ticketing system 7 or one or more client devices 2.

Continuing, each of the client devices 2 may include at least one electronic processor (client processor) and at least one associated electronic memory that stores electronic instructions that, when executed by the at least one client processor, causes the client device 2 to complete one or more of the exemplary functions, features or methods/processes disclosed herein.

For ease of reference, we may refer to the combination of a client processor and client electronic memory simply as a client device or client 2.

Similarly, each administrative user device 3a may include at least one electronic processor (administrative processor) and at least one associated electronic memory (administrative electronic memory) that stores electronic instructions that, when executed by the at least one administrative processor, causes the administrative device to complete one or more of the inventive functions, features or methods/processes disclosed herein.

Again, for ease of reference, we may refer to the combination of an administrative processor and administrative electronic memory simply as an administrative user device or “administrative device” 3a.

In an embodiment, the electronic memory or database 5 communicatively connected to an administrative device 3a may further be configured to store electronic instructions (e.g., JavaScript; React.js or Vue.js) that will allow a user of the device 3a (e.g., an event promoter) to develop, edit and otherwise manage an interactive, frontend graphical user interface (GUI) 3b (e.g., the display shown as part of device 3a along with a mouse-like control device) that, among other things, allows client devices 2 to have web-based access to the inventive methods described herein.

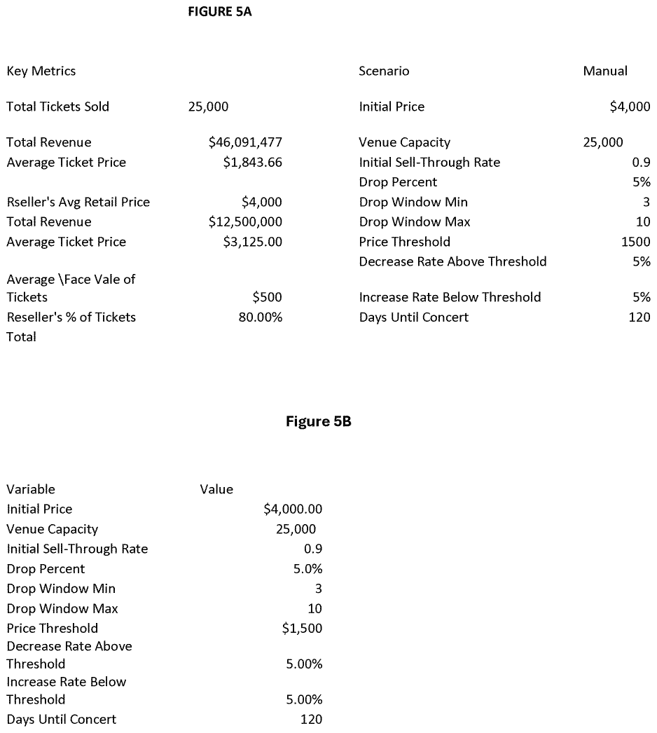

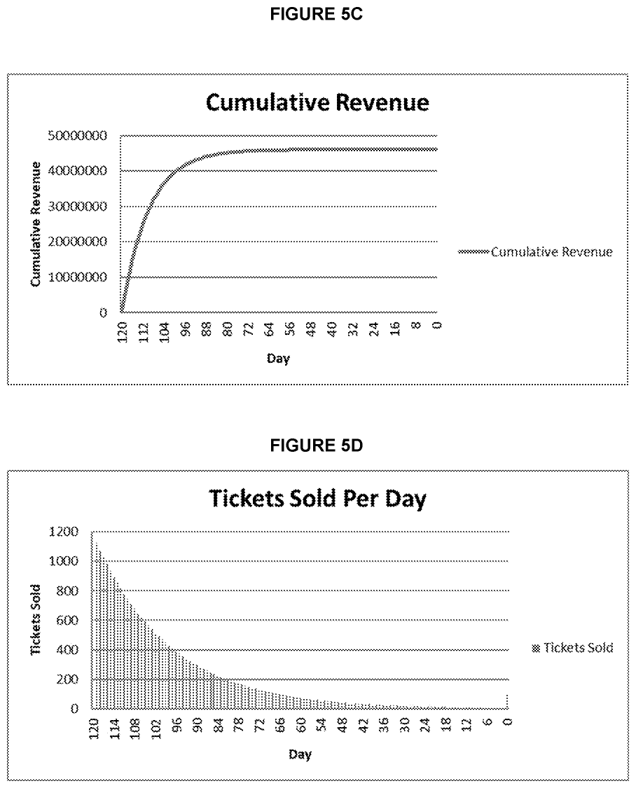

In addition, the administrative device 3a may be configured to display on its GUI 3b a plurality of sets of data, such as (i) ticket sales velocity, (ii) remaining inventory of tickets, (iii) ticket revenue projections, and (iv) historical comparisons of past versus present ticket sales for an event, (v) cumulative share of tickets sold, (vi) discount level (in percentages), (vii) ticket price versus time period of published sale (e.g., a time-indexed price “ladder”), and (viii) the time remaining before commencement of the event to name just a few of the many, many sets of ticket-related data that may be displayed by the GUI 3b of the administrative device 3a. Some additional data sets and dashboards that may be generated by the administrative device and displaced on its GUI 3b are shown in FIGS. 5A to 5D. Said another way, the system 3 can be said to electronically monitor the data related to items (i) to (viii) above among the many other data sets that may be monitored by the system 3.

Again, it should be understood that the data sets and dashboards discussed herein and/or shown in the figures are only some of the many data sets and dashboards that may be generated by the administrative device 3a and displayed on its GUI 3b. Some other data sets and dashboards that may be displayed are daily simulations, ticket totals and averages as well as revenue.

Continuing, in an embodiment, each server 4 may also include at least one electronic processor (serving processor) and at least one electronic, associated memory (serving memory) that stores electronic instructions that, when executed by the at least one serving processor, causes the server to complete one or more of the inventive functions, features or methods disclosed herein. In an embodiment, the electronic instructions executed by the serving processor may comprise (i) Python programming code, (ii) Node.js programming code and/or (iii) Pandas/NumPy programming code for data “crunching” (i.e., processing, analyzing, or manipulating large data sets), for example, in order to complete one or more steps of an exemplary method disclosed herein.

Each of the servers 4 may further comprise (or be communicatively connected to) at least one electronic database 5 that stores electronic data, such as historical data, that can be electronically or communicatively retrieved and electronically processed by a server or servers 4 as part of an exemplary method disclosed herein.

For ease of reference, we may refer to the combination of a server processor, serving electronic memory and associated database 5 simply as a “server”.

For the sake of brevity, and to avoid repetition, it should be understood that when the discussion herein indicates the anti-scalping system 3, server 4, client device 2 or ticketing system 7 or some combination of such elements has completed a function, feature or step, it should be understood that it is at least the respective electronic processor of a respective administrative device 3a, server 4 or client device 2 or ticketing system 7 that executes electronic instructions from its least one memory that has caused the respective anti-scalping system 3, server 4. client device 2 or ticketing system 7 to complete such feature(s), function(s) and step(s).

Continuing, in an embodiment each database 5 may be configured as a relational database (e.g. PostgreSQL database) or as a NoSQL (Not Only SQL) database for storing/manipulating ticket and historical data.

For example, the historical data may represent values: (i) of previous time-indexed price “ladders”, (ii) of previous demand versus discount levels (in percentages), (iii) of sales and their associated initially offered sales price and their final selling sales price for an event (e.g., concert, sporting event, play); (iv) that can be used to generate time-based sales curves (e.g., % sold at 30, 15, 7, 1 days before event) by the serving processor; (v) average ticket “velocity” (i.e., how long, time-wise, it took for a specifically priced ticket and its associated seat or location to sell by type (VIP seating, General Admission seating, etc.); (vi) real-time event data; (vii) location; (viii) event and location influence factors; (ix) of a minimum or maximum price, where one example of a minimum price may be 70% of an average historical low price to avoid devaluation and one example of a maximum price may be 120% of an historical high price to avoid price gouging; and (x) of repeat or return customers.

More particularly the real-time event data may comprise one or more of the following, for example: (a) the time period (i.e., “window”) associated with the sale of a ticket for a particular event at a particular price or discount percentage, including the start date/time, end date/time of the window, price or discount percentage; (b) the total inventory (number) of tickets available and sold (by section/type); (c) for a specific event, the sales velocity (i.e., tickets sold per hour/day during the window); (d) the time remaining until the event begins; (e) the current unsold inventory of tickets for an event.

To allow for secure communications between the client devices 2, administrative device 3a, servers 4 and ticketing system 7 each of the client devices 2, administrative devices 3a, servers 4 and ticketing system 7 may be configured to store electronic instructions in their respective electronic memories (e.g., OAuth2) that provides a secure authorization framework to allow the client devices 2 to access their private data that may be stored on a server 4 or on an administrative device 3a.

In an embodiment, to allow the administrative device 3a (as well as a client device 2) to access the ticketing system 7 and its services each of the devices or systems 2, 3a and 7 may be configured with an API (e.g., RESTful APIs, Webhooks). In an embodiment the ticketing system 7 API may comprise a set of electronic instructions (i.e., rules and protocols) that allows the administrative device 3a (or a client device 2) to communicate with the ticketing system 7.

In an embodiment, each client device 2 may comprise its own GUI 2a, 2b. Such a client GUI 2a, 2b may be configured to display one or more of the following: (1) the initial value of a ticket for an event; (2) a present ticket price that is computed in real-time by the system 3 using an exemplary time-indexed pricing values (e.g. a “pricing ladder”) ; (3) an indication (e.g., a time or time window) when the next present ticket price in the time-indexed pricing ladder will be displayed based on the time threshold; (4) historical prices of previous ticket prices for similar events and at a given time; (5) images of those individuals who may be performing at the event, as well their trademarks; (6) images of a venue; (7) seating/ticket maps for an event; (8) amenities offered at an event, food options, parking areas and pricing, VIP areas, accessibility, restrooms; (9) related events that are computed by an artificial intelligence (AI) and machine learning based electronic instructions stored in the system 3 based on a user (of a client device 2) historical behavioral data, or based on a genre, artist, and location; (10) notifications (e.g., events a user of a client device 2 has requested to be alerted to) and notification settings; (11) user account information, including purchase history dates and events, favorited artists and teams; (12) an indication of the seat locations available to be purchased for an event and those that have already been purchased for the event; (13) a menu that allows a client to input the seats/tickets desired to be purchased, and group/configure or pattern the location of their seats/tickets (up to six) as they choose, as available, rather than in a single row or grouping, (14) one or more menus and associated indicators that allow for one or more “limit” prices and time periods to be entered into the GUI 2a, 2b by a user of client device 2 (15) a calendar of upcoming events by week, day, month or season (Spring, Summer, Fall and Winter), and (16) similar data sets and dashboards as those generated and displayed by the GUI 3b administrative device 3a .

For the reader's benefit, by limit price is meant a price that is input into the GUI 2a,2b of a client device 2 by a user that indicates the price at which the user desires to purchase a ticket to an event in the future. For example, suppose the real-time ticket price is $100 but the user seeks to purchase the ticket for a lower ticket price of $90. Accordingly, the GUI 2a,2b of the client device 2 is configured to display a menu that allows the user to input a lower price of $90 via the GUI 2a,2b . This price may be referred to as a “limit” price.

Thereafter, the limit price may be sent to one or more elements of the system 3 and stored. As the system 3 monitors the number of tickets available, and provided the system 3 indicates there are tickets still available and further provided a real-time future sales price of the ticket decreases from $100 to the limit price of $90 (i.e., the real-time ticket price “reaches the limit price”), the system 3 would be configured to reserve a ticket for the user of client device 2 (as one or more values in its electronic memory) and send an electronic message to the client device 2 which can be displayed on the GUI 2a,2b indicating the ticket for the event has been successfully purchased.

Of course, in the above example the user has input a lower limit price than the current real-time ticket price. As an option, the ticket price can be set at a higher, limit ticket price such as $110. In such a case, thereafter, the limit price may be sent to the system 3 and stored again. As the system 3 monitors the number of tickets available, and provided the system 3 indicates there are tickets still available and further provided a real-time future sales price of the ticket increases from $100 to the higher limit price of $110 (i.e., the real-time ticket price “reaches the limit price”), the system 3 would be configured to reserve a ticket for the user and send an electronic message to the client device 2 which can be displayed on the GUI 2a,2b of the client device 2 indicating the ticket for the event has been successfully purchased for the user.

An exemplary menu displayed on by the GUI 2a,2b may also include a section that allows a user to input a time period associated with the inputted limit price. For example, “one day” or “one week” or “one month” to name just a few exemplary time periods. In an embodiment the time period that is input is also transmitted to the system 3 where it is again stored.

By “associated with the inputted limit price” is meant that the inputted time period governs the time during which the limit price is valid. During a valid time period the system 3 will reserve a ticket for an event at the inputted limit price. However, once the time period has expired, the limit price becomes invalid and, thus, the system 3 will no longer reserve a ticket for an event for the user at the limit price even if the price reaches the limit price because the time period has expired.

In a further embodiment, the system 3 may be configured to compare the received limit price from the client device 2 to a statistical likelihood that such a limit price may be met. In one embodiment such a likelihood may be expressed as a percentage where 100% indicates that for certain the inputted limit price will be met while a lower percentage indicates a lower certainty that the inputted limit price can be met.

For example, some exemplary percentages are as follows
<25%
25%-<50%
50%-<75%
75-<100%
100%

Where a lower percentage indicates a lower certainty that the inputted limit price will ever be met and a higher percentage indicates a greater certainty that the inputted ticket price will be met.

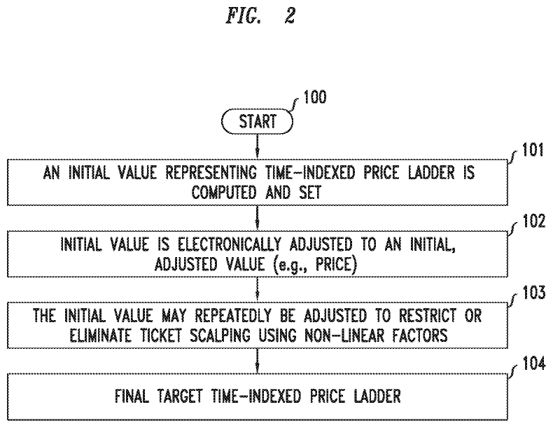

Referring now to FIG. 2 there is depicted an exemplary flow diagram of one of the exemplary methods 100 disclosed herein that may be implemented by one or more of the elements of the network 1 or their equivalents.

In step 101, an initial value representing an initial price of time-indexed pricing values (e.g., a “pricing ladder”) for an event may be electronically computed and set by an element of the inventive anti-scalping system 3. In more detail, and as will be explained more herein, the system 3 may electronically compute an initial value representing the first initial ticket price for an event based on historical ticket data stored in at least one electronic database 5.

To avoid repetition, in this embodiment it should be understood that the just described feature and the features, functions and method steps that follow may be completed by an element of the inventive anti-scalping system 3, such as its processor or one of the servers 4. In one example the computed, initial value may equal 80% to 120% of an historical value for a specific ticket for a predetermined, specific event (e.g., concert, sporting event, play) based on one or more of the types of historical data described elsewhere herein. Optionally, the computed, initial value may be selected from values representing the top 20% of historical values for such a ticket for such a predetermined event (e.g., 90% of a value selected from the top 20% of historical values to 100% of a value selected from the top 20% of historical values).

In an embodiment, to compute an initial value of the time-indexed pricing values the anti-scalping system 3 may retrieve the historical value or values from one of the databases 5 associated with one or more of the servers 4 or such value or values may be retrieved from other databases.

It should be understood that while individual steps of the exemplary method 100 disclosed herein may be completed by the anti-scalping system 3, this is merely exemplary. Alternatively, individual steps of the method 100 may be completed by a client device 2 alone, or a combination of a client device 2 in and the anti-scalping system 3. Yet further, individual steps of the method 100 may be completed by some combination of the anti-scalping system 3, client device 2 and ticketing system 7 such as when the method involves the use of a distributed APP.

Again, for the sake of brevity, and to avoid repetition, it should be understood that when the discussion of the method 100 herein indicates the anti-scalping system 3, server 4, client device 2 or ticketing system 7 or some combination of such elements has completed a function, feature or step, it should be understood that at least the respective electronic processor of a respective administrative device 3a , server 4, client device 2 or ticketing system 7 has executed electronic instructions from its at least one memory that has caused the respective anti-scalping system 3, server 4. client device 2 or ticketing system 7 to complete such feature(s), function(s) and step(s).

Continuing, in step 102 the initial value of the time-indexed pricing values may be electronically adjusted to an initial, adjusted value (e.g., price) by the anti-scalping system 3 (for example) based on the type of event (i.e., event tier). For example, the initial value for a concert scheduled to be performed by a well-known and popular singer or band may be adjusted higher as compared to a local sporting event due to the rarity or availability of the concert, for example. In computing an adjustment to the initial value the anti-scalping system 3 may also consider historical data, such as the prior attendance and ticket sales (or lack thereof) which may cause the system 3 to generate an adjusted lower or higher initial value.

After an initial value has been initially adjusted (or left unadjusted) the method continues in step 103.

On a time-indexed basis, the initial value may be further adjusted to restrict or eliminate ticket scalping as follows during step 103.

In an embodiment, the system 3 may further adjust the initial value based on a variable, threshold time period. For example, the threshold time period may be set at 30 minutes, 1 hour, 6 to 12 hours, 12 to 24 hours, 1 day to 3 days, 3 days to 10 days, etc., The system 3 may electronically monitor the time that has elapsed since the initial value had been set or adjusted. Upon reaching a time threshold the system 3 may compute a further adjustment to the initial value (whether initially adjusted or not). This adjustment may be referred to as a subsequent, time-adjusted or time-indexed value (i.e., a new price). Thus, upon reaching every subsequent time threshold a new, subsequent time-indexed value may be computed.

Upon reaching a subsequent time threshold, each subsequent time-indexed value may be computed using one or more methods. In an embodiment, the system 3 may compute a subsequent time-indexed value by considering a previously computed time-indexed value (i.e., at the start of the method, a base price), a demand factor, a time factor and an inventory factor, where the demand factor may be computed by the system 3 based on considering values represented by the actual sales velocity divided by an expected sales velocity, for example.

In an embodiment, during step 103 the system 3 may continually compute a demand factor. Upon reaching a time threshold the system 3 may determine whether the demand factor is greater than, or less than, a demand threshold.

For example, if the demand threshold is set at a value of one, and if the system 3 computes the demand factor as being greater than one then that is an indication that the demand for a specific event is rising or holding steady (demand exceeding expectations). Thus, in computing the time-indexed value a demand factor that is greater than one may result in an increase in a subsequent the time adjusted value (i.e., an increase in the ticket price). It should be understood that by “subsequent” is meant” a price that is determined by the system 3 after the system 3 has determined an initially adjusted ticket price.

In contrast, if the system 3 computes the demand factor as being less than one then that is an indication that the demand for a specific event is decreasing (demand is lower than expectations). Thus, in computing the subsequent time-indexed values a demand factor that is less than one may result in a decrease in the time-indexed value (i.e., a decrease in the ticket price).

As noted above the subsequent time-indexed values (i.e., ticket prices in a pricing ladder) is affected by more than just a demand factor. Another factor is a time factor.

Before discussing the time factor, we note the following. It is believed that restricting or eliminating ticket scalpers must also take into consideration valid purchasers of tickets and valid sponsors (artists, band, teams, venues). Thus, the computation of a series of subsequent time-indexed values representing a series of ticket prices over time (the “ladder”) must be controlled to arrive at a final, fair-market target ticket price (hereafter “target value” or “target ticket price”) so as to restrict or eliminate a ticket scalper but not a valid purchaser.

To do so, the disclosure sets forth the use of non-linear values into the computation(s) of subsequent time-adjusted value(s) representing ticket prices (e.g., a pricing ladder) to satisfactorily control the price of a ticket to meet a final, target pricing ladder and target ticket price.

As will be explained in more detail the system 3 may electronically generate the time-indexed pricing values by applying non-linear time factor to an initial ticket price that is derived from a ratio of remaining time before the event relative to a total advertised time period for the event, and a non-linear inventory factor derived from a ratio of remaining unsold tickets relative to a total quantity of tickets available for the event to generate the initial (and subsequent) time-indexed pricing values.

In an embodiment the target ticket price and pricing ladder may be determined by the system 3 by retrieving historical ticket prices from its additional memory/database of from databases 5, for example, or from the ticketing system 7.

Continuing, as noted above subsequent time-indexed values (i.e., ticket prices in a pricing ladder) are affected by time thresholds.

In an embodiment, upon reaching a particular time threshold, a time factor may be computed by the system 3 by considering values representing the number of days remaining before a specific event is scheduled to begin divided by a value representing the total number of days since the event has been publicly advertised as determined by artist, team, event site, as befitting the event applied in a non-linear scale (e.g., a time factor or window of 48 hours for the NCAA March madness basketball events, 7 day windows for NFL playoffs or smaller time windows for World Cup events).

Such a computation may be represented by:
Time_Factor=(Days_Remaining/Total_Days)\hat{ }0.5

In an embodiment, the repeated application of a non-linear time factor (i.e., \hat{ }0.5) each time the time threshold is met may reduce the time-indexed value (e.g., ticket price) more rapidly as the number of days remaining before the event begins gets closer to the date of the actual event (“time ratio”). In an embodiment, the ticket price on the day of the event may be computed by the system 3 to be equal to: (1) the price the day before the event, (2) a predetermined price set by the venue, league or other similar stakeholders, or (3) a price set by a “day off” incentive, to name just a few examples of such a price.

In an embodiment, the greater the number of days remaining before the event the less affect the time factor has on a particular computation of the time-indexed value (ticket price). For example, in the beginning the total number of days remaining equals the total number of days so the time factor equals a value of one. As time passes and the event approaches, the greater the effect that the time factor has on the computation of the time-adjusted value (ticket price).
100% time left→1=1\sqrt{1}=11=1
25% time left→0.25=0.5\sqrt{0.25}=0.50.25=0.5
1% Time Left→0.01=0.1\sqrt{0.01}=0.10.01=0.1

Accordingly, by repeatedly computing subsequent ticket prices using a non-linear time factor as time passes (i.e., as the number of days remaining before the event begins decreases) and the number of available tickets decreases (see the discussion of an inventory factor herein) the ticket price computed by the system 3 repeatedly decreases in a controlled, time-monitored fashion, which may result in the ticket price of the remaining tickets remaining at a final target value in step 104.

Similarly, upon reaching each time threshold the inventory factor may be repeatedly computed by the system 3 by considering values representing the number of remaining tickets to be sold divided by the total number of tickets available to be sold) applied in a non-linear scale. Such a computation may be represented by:
Inventory_factor=(Remaining_Tickets/Total_Tickets)\hat{ }0.3

In an embodiment, the repeated application of a non-linear time factor (i.e., \hat{ }0.3) may repeatedly reduce the time-indexed value (ticket price) more rapidly as the number of unsold tickets remains close to the total number of number tickets available and vice-versa (the reduction in the ticket price slows the fewer the number of remaining tickets).

For example:

If a computed ratio of remaining tickets to total tickets is 0.1, then applying a non-linear value of \hat{ }0.3 results in an inventory factor of 0.5.

However, if a computed ratio of remaining tickets to total tickets ratio is 0.5 (“ticket ratio”), then applying a non-linear value of \hat{ }0.3 to the ticket ratio results in an inventory factor of 0.81.

In an embodiment it is believed that the repeated computation of a non-linear inventory factor will encourage faster reductions in the price of a ticket as the number of unsold inventory remains as compared to the number of overall tickets available. Further, the repeated use of a non-linear inventory factor insures that as the ticket price is reduced the reduction is not too steep, thus insuring the ticket price of the remaining tickets remains at a final target value in step 104. In sum, the reductions in ticket prices is controlled in a time-monitored fashion by the system 3 to arrive at time-indexed pricing values.

As explained in detail herein, the repeated computation of a time-indexed value to form a series of time-indexed values (i.e., a “pricing ladder”) representing a ticket price or prices using non-linear time and inventory factors results in a controlled reduction of the ticket price of a specific ticket associated with a specific event as the days remaining before a specific event decreases and/or as the number of remaining tickets for the specific event decreases.

Such a controlled reduction in a ticket price is believed to substantially restrict or eliminate ticket scalpers because such scalpers must pay the same price as a valid purchaser as the present ticket price decreases.

In sum, the system 3 may electronically compute successive ticket prices (i.e., time-indexed pricing values) using one or more of: (i) a demand factor based on ticket sales velocity, (ii) a time factor based on remaining time before the event, and (iii) an inventory factor based on remaining unsold ticket inventory.

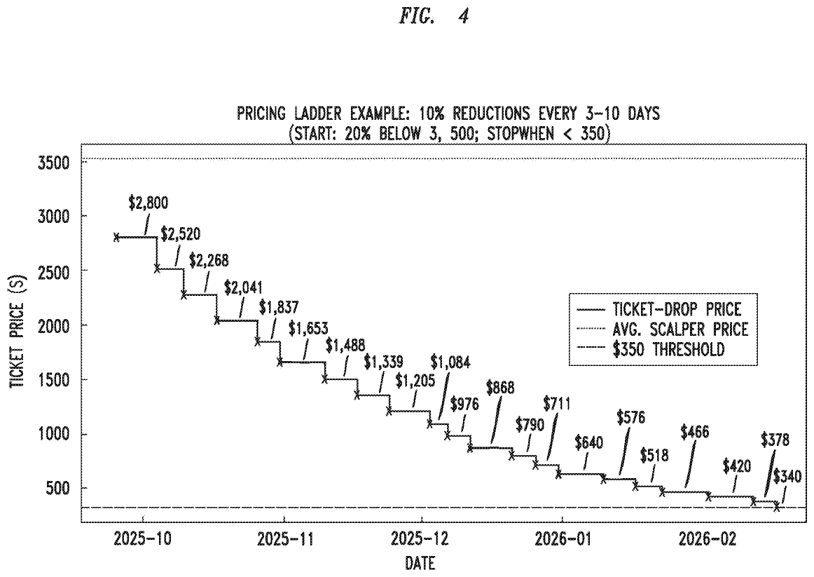

FIG. 4 illustrates one exemplary time-indexed pricing ladder for a hypothetical event. In this example, every 3 to 10 days the price of a ticket is reduced by 10% where the initial price of a ticket was set at 20% below an historical value for the specific ticket for the event. It should be understood that this initial price is merely exemplary and could be set at an initial value that is 80% to 120% of an historical value for the event or optionally set at value representing the top 20% of historical values for such a ticket for the event as noted elsewhere herein.

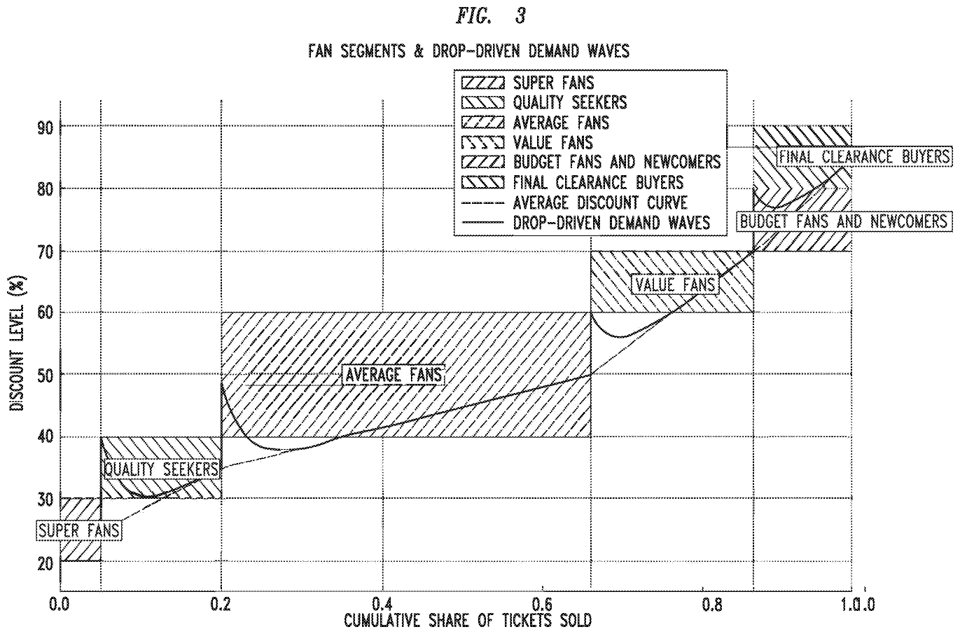

It should be understood that the generation of an initial price for a ticket may be based on a number of factors. For example, FIG. 3 provides a typical historical demand curve that may be stored as data and instructions in an electronic memory of an element of system 3 (for example) and used by an electronic processor of such an element to generate such a historical value for a ticket price.

FIG. 3 illustrates the relationship between two parameters: how many tickets have been sold (from none to all tickets sold) on the x-axis labeled “Cumulative Share of Tickets Sold”, and how much the price of a ticket has been adjusted (i.e., discounted) on the y-axis labeled “Discount Level (%)” from small discounts to very large discounts).

In an embodiment, as ticket sales progress over time, ticket prices are reduced by the system 3 in stages, and as different types of customers and distinct purchaser demand groups (“Super Fans” to “Final Clearance Buyers”) respond to these price discounts in different ways. Said another way, in an embodiment the system 3 may be configured to electronically repeatedly reduce ticket pricing in controlled stages corresponding to distinct purchaser demand groups having different price sensitivities.

For example, at the beginning only a small number of tickets are purchased, and the corresponding price is adjusted/discounted little. The first group of buyers (i.e., users of a client device 2), referred to as “Super Fans,” purchase tickets early because such purchasers are not very price sensitive. Instead, they are motivated by a strong desire to attend the event and are willing to pay higher prices to secure their tickets.

As time progresses the system 3 reduces the ticket price by an amount (e.g., a percentage) over a time period (e.g. 3 to 10 days), and a second group of buyers enters the market. These customers, referred to as “Quality Seekers” are somewhat more price-conscious. They prefer to wait for a modest discount in the price of a ticket before purchasing but still value a good experience and are willing to buy before ticket prices drop significantly.

Next, as the price of a ticket decreases further, a larger group known as “Average Fans” begins to purchase tickets. This group represents the broad middle of the market. These customers balance price and interest, typically buying when prices are reduced somewhat rather than at the earliest or latest stages.

As ticket prices are adjusted downward further, more price-sensitive customers begin to participate as purchasers. “Value Fans” wait for more substantial discounts (i.e., price reductions) before buying. They are primarily motivated by getting a good deal and are less concerned about purchasing early.

Following this group are “Budget Fans and Newcomers.” These customers are highly sensitive to price and tend to wait until tickets become significantly reduced in price. They may include individuals who were not initially planning to attend but decide to purchase once prices fall far enough.

Finally, “Final Clearance Buyers” enter the market. These customers wait for the deepest reductions in ticket prices, often purchasing tickets at very low prices shortly before the event.

FIG. 3 illustrates the idea that each time the price is reduced—referred to as a “price drop” a new group of customers who were waiting for that price level decides to purchase tickets. This results in a burst of buying activity. After such a burst, sales slow until the next price adjustment occurs downwards.

This pattern reflects real-world behavior that is taken into account by the system 3 as it generates time-indexed pricing values, such as the one shown in FIG. 4.

Customers often delay purchases until prices reach a level they find acceptable. When that level is reached, many buyers act at once, creating noticeable spikes in demand as shown in FIG. 3. In contrast, a simplified or “average” expectation might assume that ticket sales increase steadily as prices decrease. However, FIG. 3 demonstrates that actual customer behavior is more dynamic and occurs in stages tied to specific pricing thresholds.

In summary, FIG. 3 illustrates that different groups of customers have different price sensitivities, and that ticket sales are driven by a stepwise price reduction (a pricing ladder) that triggers demand. This understanding is embedded in the stored electronic instructions and data electronically stored in one or more memories of the system 3 and used by the system 3 to generate a pricing strategy for an event (a per event pricing ladder), inventory management of tickets, and predicting how and when tickets are likely to sell.

In addition to the incorporation of non-linear factors in generating ticket prices (e.g., time-indexed pricing values), the disclosure herein also provides additional anti-scalper features which can be combined with the time-indexed pricing values (e.g., referred sometimes herein as “price ladders”).

For example, existing ant-scalping methods tend to keep their future prices confidential and, therefore, potential purchasers are left to guess what the future price of a ticket may be. This encourages scalpers. Instead, in embodiments of the disclosure a system 3 generates one or more prices of a price ladder and outputs such prices to the network 1 (e.g., to client devices 2 and ticketing system 7) in advance of their actual availability time-wise.

Using the pricing ladder in FIG. 4 as an example, in an embodiment after (or at the same time) the initial price of $2,800 per ticket has been published by outputting the initial price to the network 1 and it's connected users (e.g., client devices 2 and ticketing system 7) the system 3 generates one or more next prices $2,520, to $340 and their corresponding time periods (e.g. all ticket prices and time periods) and outputs one or more of the next prices to the network 1 in advance of the date of the first reduction in ticket price, for example (e.g., before the time period when the ticket price is $2,520).

Alternatively, the system 3 may generate a price reduction value, in this case 10%, and a set time period (e.g., every 3 to 10 days) during which time each subsequent price reduction will occur (e.g., $2,520 to $2,260) and output the set price reduction value (10%) and corresponding time periods to the network 1 in advance of the date of the first reduction in ticket price.

Yet in another embodiment, a system 3 may generate, and output to the network 1 only some of the future prices and their corresponding time periods that have not already been output to the network 1 in advance (i.e., before the earliest date of a corresponding time period that has not been output to the network 1 already).

Accordingly, using FIG. 4 again as an example, the system 3 may output: (1) all of the future prices in a time-indexed price ladder and their time periods from the beginning (at, or soon after, the initial price is output to the network 1), or (2) some of the next prices and time periods that have yet to be output to the network 1.

It should be understood by “output to the network 1” is meant that the ticket prices and their corresponding time periods that have not been made public are made known to the public by publishing the prices to client devices 2 via network 1, or at least to those clients 2 and ticket systems 7 that have access to the network 1.

It can be said that the time-indexed pricing values and the methods of outputting them provided by the instant disclosure result in the transparent publishing of future ticket prices for an event in advance of the tickets being purchased which leads to a reduction in, or elimination of, ticket scalping.

Further, it should be understood that for a given time window all tickets for an event in all sections of a venue are reduced in price together and at the same time according to a published schedule.

So far we have discussed methods that effectively control the pricing of tickets for an event to prevent scalping. It should be noted that other methods may be implemented by the system 3 in conjunction with client devices 2 and the third party ticketing system 7 to prevent scalping. In sum, this disclosure describes computer-implemented methods for restricting or eliminating ticket scalping using a closed ticket purchase system that includes, at a minimum, system 3 that comprises at least one electronic processor and at least one electronic memory that enables the system 3 to: electronically generate time-indexed pricing values that in turn comprise a plurality of future ticket prices respectively associated with corresponding future time periods for an event; and electronically output 9 i.e., publish) prior to occurrence of at least one of the corresponding future time periods, at least a portion of the time-indexed pricing values and the corresponding future time periods to a plurality of client devices 2 or the third party ticketing system 7 over a telecommunications network 1 such that future ticket pricing is transparently published in advance of ticket purchase transactions.

In sum, in embodiments of the disclosure the system 3 electronically publishes future pricing information to client devices 32 and/or the third party ticketing system 7 sufficiently in advance to reduce information asymmetry between ticket purchasers and ticket resellers.

In addition to transparently publishing in advance time-indexed pricing values for an event the inventors disclose other anti-scalping methods.

It should be understood that the use of the word “ticket” in this disclosure denotes an admission right and credential that is granted to a ticket purchaser upon receipt of a payment indication from the purchaser (i.e., user of a client device 2) by the system 3, for example. Said, another way, the present disclosure does not make available a physical (paper) ticket unless it is a souvenir ticket which is explained elsewhere herein. Instead, the purchase of a ticket provides the purchaser with a revocable, identity-bound admission credential or “ticket”.

As will be explained in more detail, in one embodiment elements of the system 3 electronically generate—responsive to completion of an original ticket purchase transaction—a revocable identity-bound admission credential associated with unique identifying information.

In more detail, the system 3 is configured to implement a computer-implemented method for controlling revocable identity-bound admission credentials for an event.. The system 3 may electronically receive a request to purchase at least one ticket for an event from a client device 2 or a third party ticketing system 7 over a telecommunications network 1 and purchaser-specific identifying information associated with a purchaser. Such purchaser-specific identifying information may uniquely identify the purchaser and may comprise one or more of: a government identification, biometric identification, unique device identification, smartphone verification identification, account-based verification identification, behavioral verification identification, or cryptographic identification.

Responsive to approval of the purchase request, the system 2 may electronically generate a revocable identity-bound admission credential corresponding to the purchaser and the event. Further, system 3 may further electronically generate a unique electronic code associated with the revocable identity-bound admission credential and store the unique electronic code in memory. In some embodiments, the unique electronic code comprises a quick-response (QR) code associated with the ticket purchase transaction. Thereafter, the system 3 may electronically transmit the unique electronic code to the client device 2 associated with the purchaser.

The purchaser-specific identifying information, the revocable identity-bound admission credential, and the unique electronic code may be electronically associated with the ticket purchase transaction and stored in memory by the system 3 for later verification and authorization processing.

In an embodiment, by requiring verification of the revocable identity-bound admission credential, the system 3 eliminates the need to circulate a paper ticket bearer instrument and thereby substantially reduce unauthorized ticket distribution and resale activity.

In one embodiment, to gain admission to the event, admission-control equipment at a venue may electronically receive verification information associated with the unique electronic code from the system 3. For example, the admission-control equipment may electronically communicate with the system 3 to verify that the unique electronic code corresponds to an authorized ticket transaction associated with the purchaser-specific identifying information. In an alternative embodiment, the admission-control equipment electronically communicates with the system 3 through the third party ticketing system 7 to verify the revocable identity-bound admission credential.

The system 3 may further restrict transfer and resale of the revocable identity-bound admission credential such that all transfer requests and resale transactions are required to be processed through the system 3. Said another way the system 3 is configured to electronically control resale transactions to prevent external resale transactions outside the system 3. In such embodiments, the system 3 may electronically deny admission or transfer authorization when the unique electronic code fails verification against stored transaction data maintained by the system 3.

In some embodiments, verification of the revocable identity-bound admission credential may include re-verification upon transfer of a ticket from one purchaser to another, chain-of-custody verification methodologies, dynamic credential invalidation methodologies, and rolling credential regeneration methodologies implemented by the system 3 in conjunction with the client device 2 and/or the third party ticketing system 7.

It should be understood that the closed ticket purchase system 3 is utilized for the purchase and resale of all tickets, including, but not limited to those tickets that are put on “hold” (e.g., house seats, comps, and VIP allocations)—withheld from public sale. Such a hidden inventory of available tickets creates unwanted effects—artificial scarcity, distortion of price discovery—and introduces information asymmetry between insiders and public consumers. As a result, the public is not participating in a fair market, but rather in a constrained and partially concealed supply environment. These unwanted effects are removed by the innovative closed ticket purchase system 3.

In an embodiment, the system 3 includes the entire inventory of tickets in its time-indexed pricing values (i.e., all ticket availability is transparent) for all tickets at all times. To the extent that tickets are placed on “hold”, the system 3 publishes this information to the network 1 (outputs the information to the network 1) so that all purchasers (i.e., a user of a client device 2, third party ticketing system 7) are made aware of such tickets.

Further, all resales of such “held” tickets must be purchased through the same closed ticket purchase system 3. As noted herein, each ticket is associated with a unique code (e.g., a QR code) known only to authorized admission systems thus insuring the prices of such “held” tickets are not available to scalpers. In sum, the innovative systems provided by the instant disclosure does not eliminate “held” tickets. Rather, it makes their existence transparent, finite, and non-exploitable.

Earlier, we discussed the setting of an initial ticket price. It should be understood that the system 3 separately or by electronically communicating with third party ticketing system 7 may set the initial value (price) of a ticket at a lower price (i.e., price floor) to prevent deliberate undercutting of the price.

As noted above, the price of a ticket may be determined by the system 3 by retrieving historical ticket prices from databases 5, for example, and generating time-indexed pricing values. In embodiments, thereafter a ticket price may also be further adjusted.

For example, after a ticket price has been generated by the system 3, the system 3 may apply an additional discount based on, for example, whether (1) the ticket or tickets are being purchased by a repeat purchaser (i.e., customer), or (2) are being purchased in bulk. In one embodiment a ticket price may be decreased by a 5-10% discount for repeat customers and 10% for bulk purchases of 4 tickets or more.

Before we mentioned that the system 3 generates souvenir tickets. It should be understood that such a souvenir ticket does not function to grant admission to an event. Instead, in an embodiment the system 3 may generate such tickets as a way to memorialize the event.

In more detail, a client device 2 or the third party ticketing system 7 may send an electronic indication or signal to the system 3 that indicates a user of the client device 2 or the system 7 has requested to purchase a souvenir ticket. Upon receiving such an indication or signal the system 3 may electronically exchange purchasing information with the client device 2 or system 7 via network 1 which sets forth the details of the type of souvenir ticket presently available and the price of such a ticket. Upon receiving additional signals indicating that a user of the client device 2 or system 7 has purchased such a souvenir ticket the system 3 may forward or otherwise send the details of the type of souvenir ticket which was purchased to a fulfillment center (not shown in Figures) in order to fulfill the purchase of the souvenir ticket.

In the discussion herein we have described methods that make use of electronic processors which retrieve and execute electronic instructions from at least one electronic memory to complete features, functions and methods.

It should be understood that the processors and memories of elements of system 3 may further comprise an AI system. In embodiments, the AI based system 3 may be configured to analyze data related to ticket purchase transactional behavior, market indicators, and ticket resale activity to generate a demand authenticity score (value) that represents authentic consumer demand for an event.

Upon generating a demand authenticity score, the system 3 may dynamically adjust ticket pricing, ticket allocation, transfer permissions, and purchasing controls. The system 3 may be further configured to detect and identify synthetic demand patterns associated with bots and scalpers and apply adaptive, electronic mitigation mechanisms including dynamic friction, resale governance, and identity-linked ticket controls described above.

In addition to generating an initial ticket price or value based on the description above, the system 3 may also set an initial ticket price or generate a pricing ladder based on other data and signals it receives from client devices 2 and ticketing system 7

For example, the system 3, may first generate a real-time authenticity score derived from data received by the system 3 to determine time-indexed pricing values.

Such data may include data related to: click-to-purchase ratios, purchase completion speeds, cart abandonment frequencies, seat selection concentrations, repeat transaction attempts, social-media trend accelerations, search-volume surges, local event conflicts, and weather forecasts. secondary-market listing velocity, markup percentages, cross-platform arbitrage behavior, and immediate resale attempts.

As noted elsewhere the system 3 may generate an initial time-indexed pricing value based on the type of event.

For example, when the event is a concert the system 3 may preserve an initial ticket price during a time period that corresponds to an authentic fan surge. Alternatively the system 3 may restrict transfers during broker-detected spikes, and apply controlled late-cycle price caps during fear-of-missing-out purchasing phases.

For sporting events, the system 3 may implement lottery-based allocation during rivalry-game oversubscription, soften pricing during adverse weather forecasts, and bundle supplemental products during low-demand periods.

For festivals, the system 3 may generate intermediate ticket pricing tiers after accelerated sellouts, substitute value-added incentives for discounts, and freeze resale ticket margins during late-stage demand spikes.

The system 3 above includes many features and functions. In addition to the features and functions above the system 3 may be configured to analyze: ticket purchase velocity, user browsing behavior, user refresh frequency, user ticket quantity requests, client device 2 signatures, IP distribution, geolocation inconsistencies, and cross-event transactional patterns of users.

Further, as noted elsewhere herein the system 3 may be configured to modify ticket prices in real time, as well as generate hidden promotional ticket pricing, create intermediate pricing tiers of a pricing ladder, and enforce price ceilings or floors in a pricing ladder.

To further prevent fraud the system 3 may execute instructions from its memory or execute an APP that detects and identifies bot-like or broker-like activity. Yet further, the system 3 may execute instructions from its memory or execute an APP that restricts transfers, enforces identity verification, caps resale margins, delays ticket transfer eligibility, and applies dynamic purchasing friction.

### Regulatory Integrity Framework

In one embodiment, the system 3 is configured to electronically maintain and store compliance-oriented transparency records including, but not limited to, pricing decision logs, demand authenticity calculations, anti-bot intervention records, and resale governance actions.

The system 3 thereby supports regulatory auditing, consumer-protection compliance, anti-manipulation enforcement, and marketplace fairness verification.

It should be understood that the inventive devices and methods described herein are only some of the many embodiments that fall within the scope of the disclosure and claims that follow, it being impractical to discuss all possible embodiments.

We claim:

1. A computer-implemented method for restricting or eliminating ticket scalping using a ticketing system comprising at least one electronic processor and at least one electronic memory, the method comprising:
electronically generating, by the ticketing system, time-indexed pricing values comprising a plurality of future ticket prices respectively associated with corresponding future time periods for the event;
electronically outputting, by the ticketing system, prior to occurrence of at least one of the corresponding future time periods, at least a portion of the time-indexed pricing values and the corresponding future time periods to a plurality of client devices or a third party ticketing system over a telecommunications network such that future ticket pricing is transparently published in advance of ticket purchase transactions;
electronically generating, by the ticketing system, responsive to completion of an original ticket purchase transaction, a revocable identity-bound admission credential with unique identifying information and associating the generated credential and identifying information to a purchaser; and
electronically restricting resale ticket transactions for the event such that all ticket resales are required to be processed through the closed ticket purchase system that processed the original ticket purchase transaction.

2. The method as in claim 1 wherein the time-indexed pricing values comprise a time-indexed pricing ladder.

3. The method as in claim 1 further comprising electronically verifying, by the by the ticketing system, during a requested resale transaction that the unique electronic code and the unique identifying information remain associated with an authorized ticket transaction prior to permitting transfer of the revocable identity-bound admission credential.

4. The method as in claim 1 further comprising electronically computing, by the by the ticketing system, an initial value representing an initial ticket price for an event based on historical ticket data stored in at least one electronic database.

5. The method as in claim 1 further comprising electronically monitoring, by the by the ticketing system, at least: (i) ticket sales velocity, (ii) remaining ticket inventory, and (iii) time remaining before commencement of the event.

6. The method as in claim 1 further comprising electronically generating a unique electronic code associated with the ticket purchase transaction and storing the unique electronic code in an electronic memory.

7. The method as in claim 1 further comprising:
eliminating circulation of a primary bearer instrument by restricting admission to the event by requiring presentation of the revocable identity-bound admission credential; and
verifying the unique electronic code.

8. The method as in claim 1 wherein electronically generating the time-indexed pricing values comprises using (a) a non-linear time factor derived from a ratio of remaining time before the event relative to a total advertised time period for the event, and (b) a non-linear inventory factor derived from a ratio of remaining unsold tickets relative to a total quantity of tickets available for the event to generate the time-indexed pricing values.

9. The method as in claim 1 further comprising electronically outputting the entire time-indexed pricing values to the network.

10. A computer-implemented method for controlling electronic admission credentials for an event, the method comprising:
electronically receiving, by a ticketing system comprising at least one electronic processor and at least one electronic memory, a request to purchase at least one ticket for an event from a client device or third party ticketing system over a telecommunications network;
electronically receiving, by the ticketing system, purchaser-specific identifying information associated with a purchaser;
electronically generating, by the ticketing system, responsive to approval of the purchase request, a revocable identity-bound admission credential corresponding to the purchaser and the event;
electronically generating, by the ticketing system, a unique electronic code associated with the revocable identity-bound admission credential and storing the unique electronic code in memory; and
electronically transmitting the unique electronic code to the client device associated with the purchaser.

11. The method as in claim 10 further comprising, by the ticketing system, eliminating circulation of a paper ticket bearer instrument by restricting event admission to electronic verification of the revocable identity-bound admission credential.

12. The method as in claim 10 further comprising:
electronically receiving, from admission-control equipment at a venue, verification information associated with the unique electronic code at the ticketing system; and
electronically communicating between the admission-control equipment and the ticketing system to verify that the unique electronic code corresponds to an authorized ticket transaction associated with the purchaser-specific identifying information.

13. The method as in claim 10 further comprising restricting transfer and resale of the revocable identity-bound admission credential such that all transfer requests and resale transactions are required to be processed through the ticketing system.

14. The method as in claim 13 further comprising electronically denying admission or transfer authorization when the unique electronic code fails verification against stored transaction data maintained by the ticketing system.

15. The method as in claim 10, wherein the unique electronic code comprises a quick-response (QR) code associated with a ticket purchase transaction.

16. The method as in claim 12, wherein the admission-control equipment electronically communicates with the ticketing system through a third party ticketing system to verify the revocable identity-bound admission credential.

17. A computer-implemented method for transparently controlling ticket pricing for an event, the method comprising:
electronically retrieving, by a ticketing system, historical ticket transaction data associated with one or more prior events that are similar to the event;
electronically generating, by the ticketing system, using the historical ticket transaction data an initial ticket price for the event;
electronically generating, by the ticketing system, time-indexed pricing values comprising a plurality of future ticket prices respectively associated with future time periods before commencement of the event;
electronically computing successive ticket prices comprising the time-indexed pricing values using one or more of:
(i) a demand factor based on ticket sales velocity,
(ii) a time factor based on remaining time before the event, and
(iii) an inventory factor based on remaining unsold ticket inventory,
wherein at least one of the time factor or the inventory factor is non-linearly computed by the closed ticket purchase system.

18. The method as in claim 17 further comprising electronically publishing, by the ticketing system through a telecommunications network and prior to occurrence of corresponding future time periods, future ticket prices of the time-indexed pricing to a plurality of client devices.

19. The method as in claim 18 further comprising, by the ticketing system, disallowing reactive bidding and ticket-price auctions.

20. The method as in claim 17 further comprising electronically updating, by the ticketing system, ticket prices at successive time thresholds based on monitored event demand and monitored ticket inventory.

21. The method as in claim 17 further comprising, by the ticketing system,
electronically controlling resale transactions through the ticketing system to prevent external resale transactions outside the ticketing system, or
electronically publishing future pricing information sufficiently in advance to reduce information asymmetry between ticket purchasers and ticket resellers, or
electronically repeatedly reducing ticket pricing in controlled stages corresponding to distinct purchaser demand groups having different price sensitivities.
